(19) United States
(12) Patent Application Publication
(10) Pub. No.: US 2011/0036871 A1
(43) Pub. Date: Feb. 17, 2011

(54) TRIGGER-TYPE PUMP DISPENSER

(76) Inventors: Atsushi Tada, Tokyo (JP); Mitsuaki Shaduki, Yamaguchi (JP)

Correspondence Address: FLYNN THIEL BOUTELL & TANIS, P.C., 2026 RAMBLING ROAD, KALAMAZOO, MI, 49008-1631, US

(21) Appl. No.: 12/452,659

(22) PCT Filed: Oct. 30, 2009
(86) PCT No.: PCT/JP2009/005786

§ 371 Date: Jan. 13, 2010

(30) Foreign Application Priority Data
Dec. 9, 2008 (JP) 2008-313763

(51) Int. Cl. B67D 7/60

(52) U.S. Cl. 222/383.1

(57) ABSTRACT

[Objective] To provide a trigger-type pump dispenser having a cam mechanism which stabilizes the movement of a swing lever and prevents a biasing means for returning a piston from being affected by liquid.

[Means for Solution] A trigger-type pump dispenser A has: a body part (1) attachable to an opening part of a container main body; a cylinder part (2) integrally provided with the body part (1); a piston part (3) slidable in the cylinder part (2); a balance arm part (4) pivotally attached to the body part 1 so as to vertically slide the piston part (3); a trigger part (6) turning the balance arm part (4); a spring part (5) for returning the trigger part (6) via the balance arm part (4); and a cover member (8) attached to the body part (1); wherein movement of the trigger part (6) is transmitted to the balance arm part (4) by a cam mechanism.

### TECHNICAL FIELD

The present invention relates to a trigger-type pump dispenser in which, when a trigger part is pulled inward, a piston compresses liquid in a cylinder, thereby spraying the liquid from a nozzle part.

### BACKGROUND ART

Conventionally, a trigger-type pump dispenser has been used as a means of spraying liquid such as a chemical solution toward a predetermined location.

In the trigger-type pump dispenser, when a trigger is held and pulled inward by a user, an incorporated piston is moved, and the liquid housed in a cylinder is compressed.

Then, the compressed liquid is sprayed from a nozzle.

In this manner, the trigger-type pump dispenser can be used only by the simple operation of pulling the trigger inward; therefore, the pump dispenser is highly useful and is used in various fields.

A pump dispenser which directly couples a trigger and a piston so as to interlock the two members and, other than this, a pump dispenser having a mechanism which interlocks a trigger and a piston have been provided as such a trigger-type pump dispenser of the type in which the piston is moved by the operation of the trigger.

For example, a trigger-type pump dispenser described in Patent Literature 1 has a structure in which, when a trigger is pulled, a swing lever is inclined by a cam mechanism, and the swing lever pushes down a piston.

In other words, when the trigger of the trigger-type pump dispenser is pulled, the trigger causes the swing lever to be inclined by a cam, and the inclined swing lever pushes a transfer head downward.

Then, the downwardly-pressed transfer head pushes the piston coupled therewith. As a result, the piston compresses the liquid in a cylinder.

The compressed liquid is moved from the piston to the transfer head and is finally sprayed from a nozzle attached to the transfer head.

The piston pushed into the cylinder is pushed back to the original position by the returning force of a coil spring disposed in the cylinder. As the piston returns to the original position, the transfer head and the swing lever also return to the original positions, and the trigger is also returned to the original position by the cam between the swing lever.

In this manner, the trigger and the piston are not directly coupled to each other in those having the cam mechanism; therefore, excessive force is not applied to the trigger, and operation thereof is stable.

### Conventional Art Literature

### Patent Literature

Patent Literature 1: Japanese Patent No. 3069393

### SUMMARY OF THE INVENTION

### Problems to be Solved by the Invention

However, the trigger-type pump dispenser described in above described Patent Literature employs the structure in which one end of the swing lever is pushed up by a trigger-type lever, the other end of the swing lever is pushed down by the transfer head (integrated with the piston), and a large pressing force is applied at a free end of the swing lever. Therefore, wobbling is generated in the swing lever per se, and the movement thereof is instable.

On the other hand, since the coil spring is disposed in the cylinder, the spring is in the state that it is always immersed in the liquid housed in the cylinder, and the spring is tend to be readily corroded.

Due to these factors, the usage durable period of the trigger-type pump dispenser is shortened than the original usage durable period thereof.

The present invention was developed for solving the above described problems.

More specifically, it is an object to provide a trigger-type pump dispenser having a cam mechanism which stabilizes the movement of a swing lever and prevents a biasing means for returning a piston from being affected by the liquid.

### Means for Solving the Problems

The present inventor diligently carried out further research based on the above described problems and background, as a result, found out that the above described problems can be solved by disposing the biasing means for applying a biasing force to a piston outside a cylinder via a balance arm, and accomplished the present invention based on the finding.

The present invention resides in (1) a trigger-type pump dispenser having: a body part attachable to an opening part of a container main body; a cylinder part integrally provided with the body part; a piston part slidable in the cylinder part; a balance arm part pivotally attached to the body part so as to vertically slide the piston part; a trigger part turning the balance arm part; a spring part for returning the trigger part via the balance arm part; and a cover member attached to the body part; wherein movement of the trigger part is transmitted to the balance arm part by a cam mechanism.

The present invention also resides in (2) the trigger-type pump dispenser described above in (1), wherein the spring part has a U-shaped base part and curved spring parts curved and projected from the U-shaped base part and mutually coupled by a distal end part; and a rear end of the balance arm part is hooked on the distal end part from above in the state in which the balance arm part is partially housed in the curved spring parts.

The present invention also resides in (3) the trigger-type pump dispenser described above in (1), wherein the balance arm part has a pair of wall parts with a distance between the wall parts, and engagement projections respectively formed on both sides of the piston part are inserted in engagement holes respectively formed in the wall parts so as to mutually couple the balance arm part and the piston part.

The present invention also resides in (4) the trigger-type pump dispenser described above in (1), wherein a projecting curved-surface part formed on the trigger part abuts a front end of the balance arm part.

The present invention also resides in (5) the trigger-type pump dispenser described above in (1), wherein the distance between a contact point of the trigger part and the balance arm part and a pivotal point of the balance arm part with respect to a U-shaped base part of the spring part is always constant.

The present invention also resides in (6) the trigger-type pump dispenser described above in (1), wherein the spring part and the balance arm part are integrally formed via a separable thin part.

As long as it is consistent with the object of the present invention, a constitution of an arbitrary combination of the above described invention can be also employed.

### EFFECTS OF THE INVENTION

In the trigger-type pump dispenser of the present invention, the spring part which is a biasing means for applying a biasing force to the piston part is disposed outside the cylinder part. Therefore, the spring part is not immersed in the liquid that is in the cylinder part.

Therefore, regardless of the type of the sprayed liquid, the spring part is not affected at all.

Therefore, the trigger-type pump dispenser of the present invention is excellent in durability compared with the conventional trigger-type pump dispenser.

The mechanism transmits the force, which is applied to the trigger part, to the piston via the balance arm part pivotally attached to the body part so as to vertically move it. Therefore, the force applied to the trigger part is stably and reliably transmitted to the piston part.

Therefore, stable discharge operations can be carried out.

The spring part has the U-shaped base part and the curved spring parts curved and projected from the U-shaped base part and mutually coupled by a distal end part, and rear ends of the balance arm part coupled to the piston part are hooked on the distal end part of the curved spring parts in the state in which the balance arm part is partially housed in the curved spring parts. Therefore, the spring part is not wobbled, and the biasing force generated by the spring part is reliably transmitted to the balance arm part.

The balance arm part has the pair of wall parts with a distance therebetween. When the engagement projections respectively formed on both sides of the piston part are inserted in the engagement holes respectively formed in the wall parts, both the members are reliably coupled to each other, and the movement of the balance arm part can be properly transmitted to the piston part.

The distance between the contact point of the trigger part and the balance arm part and the pivotal point of the balance arm part with respect to the U-shaped base part of the spring part is always constant. Therefore, the force to pull the trigger part (pulling force) is also always constant and even, and unnecessary resistance is not felt on a hand.

### BRIEF DESCRIPTION OF THE DRAWINGS

FIG. 1 is a cross sectional view showing a pump dispenser of a present embodiment.

FIG. 2 is a cross sectional view showing the pump dispenser of the present embodiment in the state that a trigger is pulled.

FIG. 3 is a drawing showing a cross section of the interior of a piston part of the pump dispenser of the present embodiment (in the state before a trigger part is pulled).

FIG. 4 is a drawing showing a cross section of the interior of the piston part of the pump dispenser of the present embodiment (in the state in which the trigger part is pulled). In order to facilitate understanding, the cross sectional drawing also shows the state in which the trigger part is pulled.

FIG. 5 is a perspective view showing a spring part.

FIG. 6 is a perspective view showing a balance arm part.

FIG. 7 is a drawing showing the assembly relation of the balance arm, spring, and body part.

FIG. 8 is a perspective view showing the coupling state of the piston part and the balance arm.

FIG. 9 is an explanatory drawing showing the state in which the balance arm part and the spring part are integrally formed.

FIG. 10 is an explanatory drawing showing the distance relation from the contact point of the trigger part and the balance arm part to the pivotal point before turning and after turning of the trigger part; wherein, FIG. 10 (A) shows the state before the trigger part is pulled, and FIG. 10 (B) shows the state after the trigger part is pulled.

### BEST MODE FOR CARRYING OUT THE INVENTION

Hereinafter, a preferred embodiment of the present invention will be explained in detail with reference to drawings in accordance with needs.

In the drawings, the same elements are denoted by the same reference numerals, redundant explanations are omitted, and the positional relation of, for example, the top, bottom, left, and right are based on the positional relation shown in the drawings unless otherwise stated. Furthermore, the dimensional ratios of the drawings are not limited to the ratios shown in the drawings.

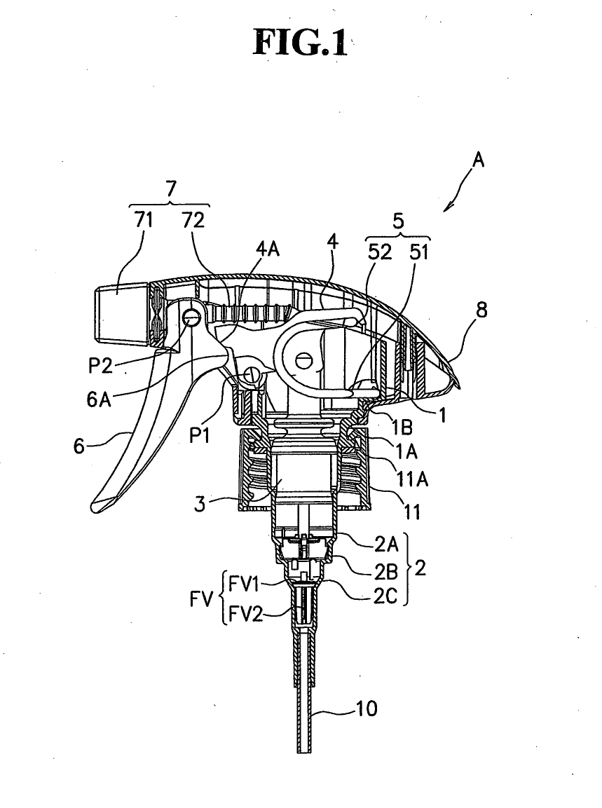

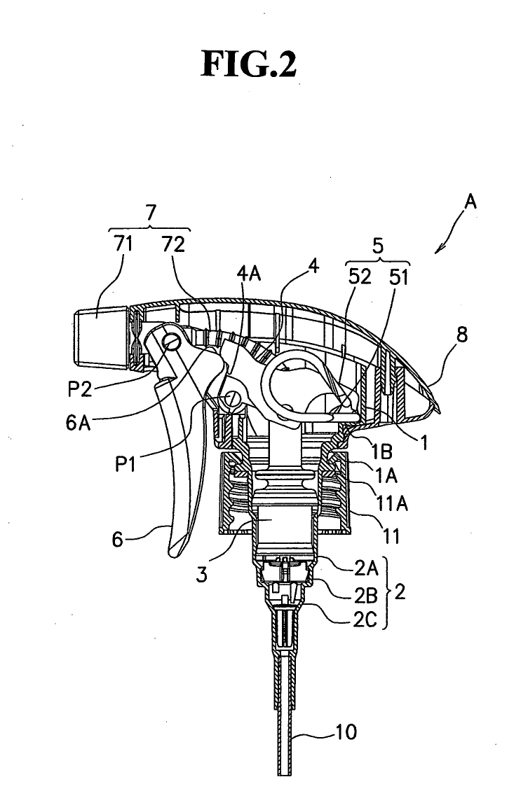

FIG. 1 and FIG. 2 are cross sectional drawings showing an embodiment of a pump dispenser of the present invention. FIG. 1 shows a state before a trigger part is pulled, and FIG. 2 shows a state after the trigger part is pulled.

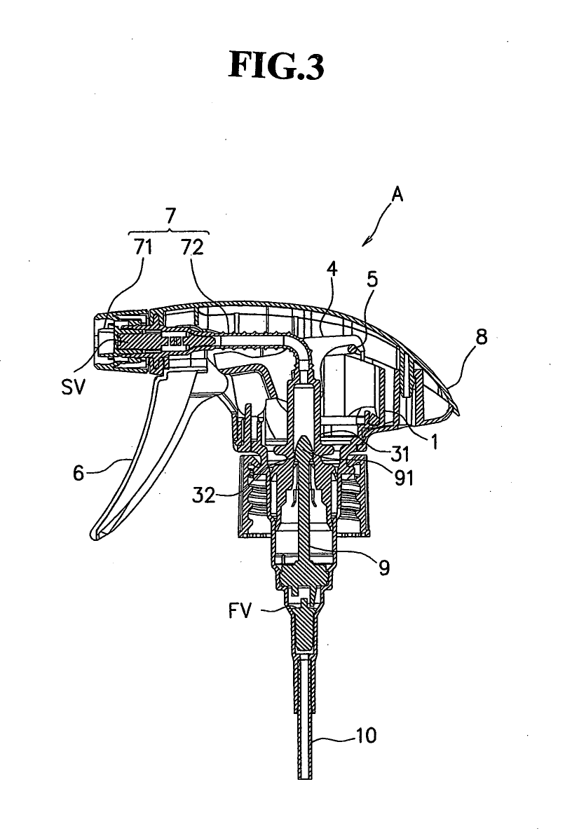

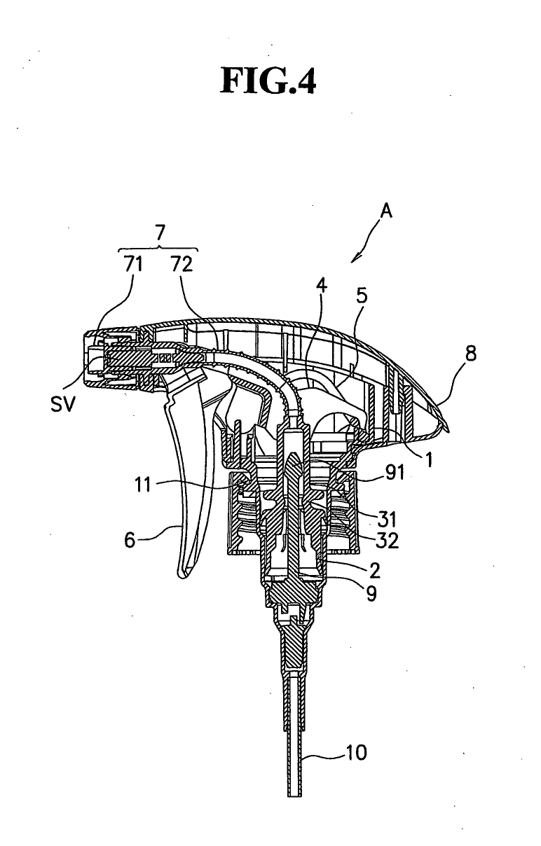

FIG. 3 and FIG. 4 are cross sectional drawings which are shown so as to facilitate understanding of the internal structure of a piston of the present embodiment. FIG. 3 shows a state before the trigger part is pulled, and FIG. 4 shows a state after the trigger part is pulled.

A trigger-type pump dispenser A of the present embodiment is used by attaching the dispenser to a container housing liquid.

When the trigger part 6 is pulled inward, the liquid is once sucked up from the container, which is not illustrated, into a cylinder part 2, and a pressure is applied to the liquid so as to spray the liquid therefrom.

The trigger-type pump dispenser A has a mechanism that a balance arm part 4 pivotally attached to a body part 1 and a piston part 3 are coupled with each other and that the piston part 3 is vertically moved by turning the balance arm part 4 by the trigger part 6.

Moreover, since the balance arm part 4 is in contact with the piston part 3 at an intermediate position at which the balance arm part is not a free end, the force applied to the trigger part 6 is reliably transmitted to the piston part 3, and stable discharge operations can be carried out.

A spring part 5 for returning the balance arm part 4, which is inclined by the trigger part 6, to the original position is disposed outside the cylinder part 2.

Therefore, the spring part 5 does not contact the liquid housed in the cylinder part 2 at all.

As a result, different from the conventional trigger-type pump dispenser, corrosion of the spring part 5 due to the influence of the liquid is completely avoided, and the dispenser can be stably used for a long period of time.

Furthermore, since the movement of the trigger part 6 is transmitted to the balance arm part 4 by a cam mechanism, different from the case in which the piston part 3 is directly pushed down by the trigger part, excessive force is not applied to the coupling part of both the members, and damages, etc. due to mechanical fatigue are not readily caused.

Therefore, the dispenser can be used for a long period of time.

As shown in FIG. 1, FIG. 2, FIG. 3, and FIG. 4, the trigger-type pump dispenser A has: the body part 1 which can be attached to an opening part of a container housing liquid; the cylinder part 2 integrally formed with the body part 1, the cylinder part 2 for temporarily housing the liquid sucked up from the container; a piston part 3 which slides in the cylinder part 2, the piston part 3 for compressing the liquid in the cylinder part 2; the balance arm part 4 which turns in order to vertically slide the piston part 3; the spring part 5 which applies biasing force to the balance arm part 4 in order to return the balance arm part 4, which is turned downward, to the original position; the trigger part 6 for turning the balance arm part 4; and a nozzle part 7 which is a flow channel for spraying the compressed liquid to outside of the pump dispenser.

The above described parts are mutually coupled and constitute one module as a structure of the pump dispenser.

A cover member 8 covers the internal structure of the structure of the pump dispenser in order to protect the internal structure, functions as a cover, and prevents foreign matter from entering the interior from outside.

A cap 11 is attached to the body part 1. When the cap 11 is fixed to an opening part of the container by screwing or the like, the trigger-type pump dispenser A is fixed to the container.

A claw part 11A which is formed to be inclined inward is provided at an upper end of the cap 11. When the trigger-type pump dispenser A is inserted into the cap 11 so as to be thrust in from the upper side, the claw part 11A enters into an engagement groove 1A formed on a side surface of the body part 1, and the body part 1 and the cap 11 are reliably coupled with each other.

In addition, in a lower part of the cylinder part 2, a first diameter-reduced part 2B, which is formed to have a diameter smaller than that of a cylinder main body part 2A in which the piston part 3 is incorporated, and a second diameter-reduced part 2C, which is continued therefrom and has a further reduced diameter, are provided.

A first valve FV is attached to the second diameter-reduced part 2C so as to prevent the liquid, which is sucked up from the container, from flowing back and returning into the container again. More specifically, a taper wall of the second diameter-reduced part 2C serves as a valve seat for a valve FV1 of the first valve FV.

In addition, a cross-shape rib FV2 extended to the valve FV1 is attached to the second diameter-reduced part 2C at a lower end part of the cylinder part 2 and guides the vertical movement of the first valve FV. A tube part 10 is attached to the second diameter-reduced part 2C.

A leak valve 9 is attached to the first diameter-reduced part 2B. The leak valve 9 prevents the liquid from being leaked from the nozzle part 7 when the pump dispenser A falls (see FIG. 3 and FIG. 4).

When the piston part 3 is positioned at a top dead point, a bulged part 91 formed at a distal end part of the leak valve 9 abuts a valve seat 32 which is formed to be tapered at a lower end part of a rod tube part 31.

Thus, the communication between the cylinder part 2 and the rod tube part 31 is completely disconnected, and the liquid is not leaked from the nozzle part 7 even when the pump dispenser A falls.

The nozzle part 7 and the rod tube part 31 of the piston part 3 are communicated with each other. When the liquid in the cylinder main body part 2A is compressed by the movement of the piston part 3 in the cylinder part 2, the liquid is sprayed to outside of the pump dispenser A through the nozzle part 7.

The nozzle part 7 has a nozzle opening 71 and a coupling part 72 for coupling the nozzle opening 71 with the piston part 3.

Furthermore, a second valve SV for preventing the liquid from being leaked from the nozzle opening 71 into the outside air after spray of the liquid is provided inside of the nozzle part-side of the coupling part 72.

As well as the shape of the first valve FV, the shape of the second valve SV is a shape of a combination of a disk-like valve and a cross-shape rib.

Only one spray opening is formed at the nozzle opening 71 of the present embodiment. However, a plurality of spray holes having mutually different shapes may be provided at the nozzle opening 71 in order to change the shapes of the sprayed liquid.

In that case, corresponding to the state of usage of the pump dispenser A, the liquid having the shapes suitable for each case can be sprayed.

The coupling part 72 is a tube having an accordion-like (bellows-like) periphery and has a certain stretching property and bending property.

Since the coupling part 72 has the stretching property and the bending property in this manner, the piston part 3 can be vertically moved in the state in which the nozzle opening 71 is fixed to the body part 1 and the cover member 8.

Therefore, in the trigger type pump dispenser A, the nozzle opening 71 is not vertically moved upon spraying of the liquid, and a spray object can be easily targeted at.

Incidentally, the spring part 5 of the present invention is disposed outside the cylinder part 2, although an object thereof is to return the trigger part 6 via the balance arm part 4.

Therefore, the spring part 5 does not contact the liquid, which is housed in the cylinder part 2, at all.

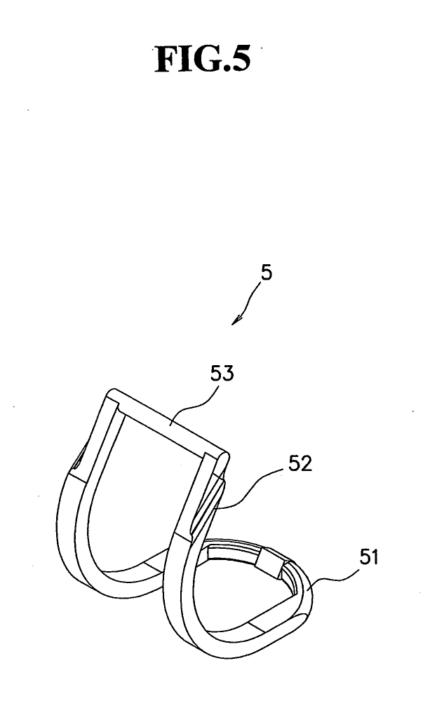

FIG. 5 is a perspective view showing the spring part.

As shown in the drawing, the spring part 5 comprises a U-shaped base part 51 and a pair of curved spring parts 52 which are curved and projected from the U-shaped base part 51 and mutually coupled by a distal end part 53 thereof. The U-shaped base part 51 is disposed on a base-part placement part 1B formed on the body part 1 (see FIG. 1).

On the other hand, an object of the balance arm part 4 is to transmit the movement of the trigger part 6 to the piston part 3.

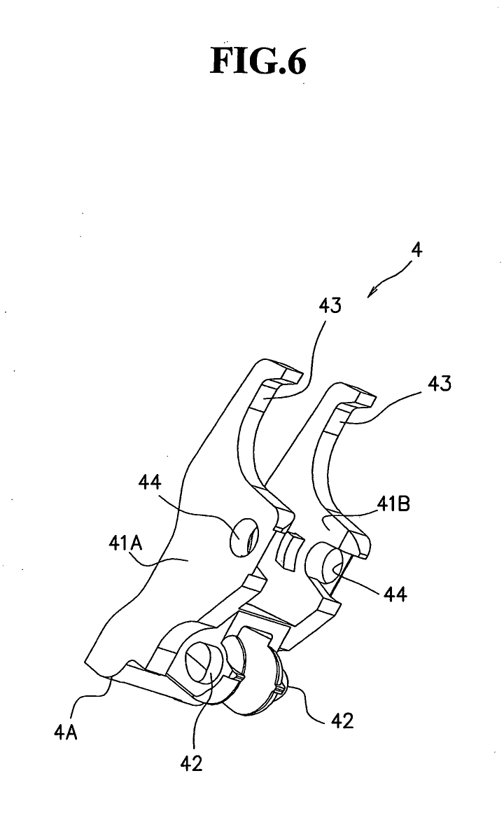

FIG. 6 is a perspective view showing the balance arm part.

As shown in the drawing, the balance arm part 4 has a pair of wall parts 41A and 41B with a distance therebetween, and an engagement projection 42 is formed on each of the wall parts.

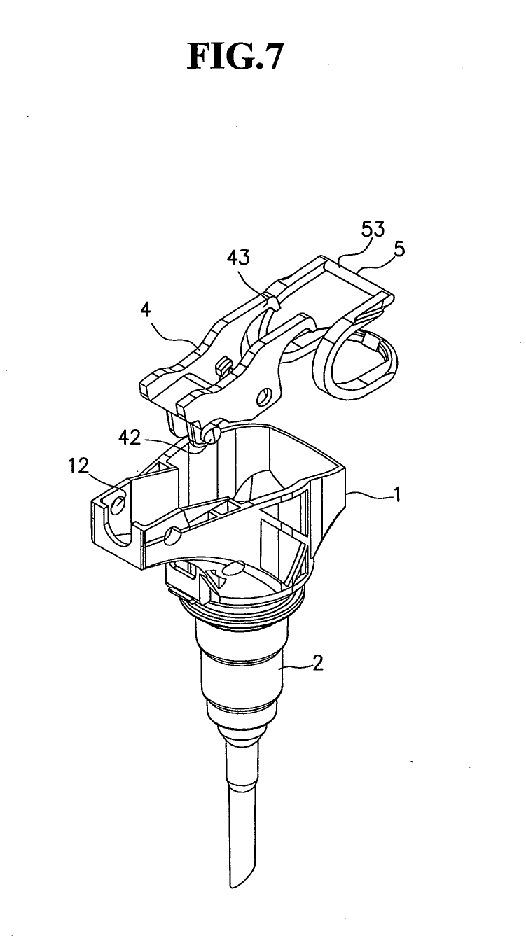

When the engagement projections 42 fit in engagement holes 12 formed on the inner walls of the body part 1, the balance arm part 4 is pivotally attached to the body part 1 (see FIG. 7).

Rear ends 43 of the balance arm part 4 are hooked on the distal end part 53 of the spring part 5 from above. Therefore, the contact part of the balance arm part 4 and the spring part 5 is extremely small.

Furthermore, at this point, the balance arm part 4 is in a partly-housed state so that the balance arm part 4 is sandwiched between the pair of curved spring parts 52 possessed by the spring part 5. Therefore, the balance arm part 4 is not wobbled relative to the spring part 5.

As a result, the spring part 5 can properly apply a returning force to the balance arm part 4.

In each of the wall parts 41A and 41B of the balance arm part 4, an engagement hole 44 is formed behind the formation position of the engagement projection 42.

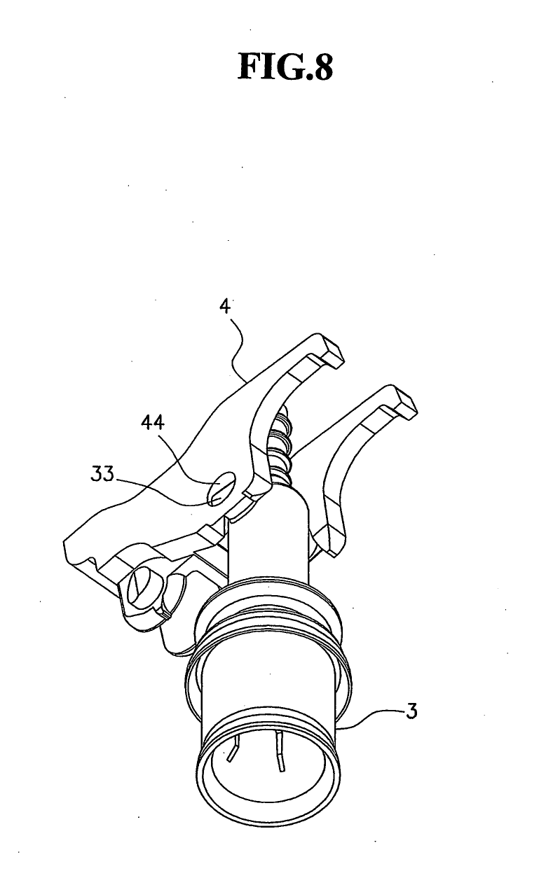

When engagement projections 33 formed on both sides of the piston part 3 are inserted in the engagement holes 44, the balance arm part 4 is pivotally attached to the piston part 3 (FIG. 8).

When the balance arm part 4 is turned about a pivotal point P1 with respect to the body part 1, the piston part 3 is vertically moved in the cylinder part 2 corresponding to the movement thereof.

In this manner, the balance arm part 4 is disposed so as to hold the piston part 3. Therefore, the coupling of both the members is ensured, and the balance arm part 4 can stably move the piston part 3 vertically.

Incidentally, the balance arm part 4 and the spring part 5 which are important assembly parts of the pump dispenser are preferred to be made of the same material and similarly have high quality.

Therefore, the balance arm part 4 and the spring part 5 are integrally formed in manufacturing.

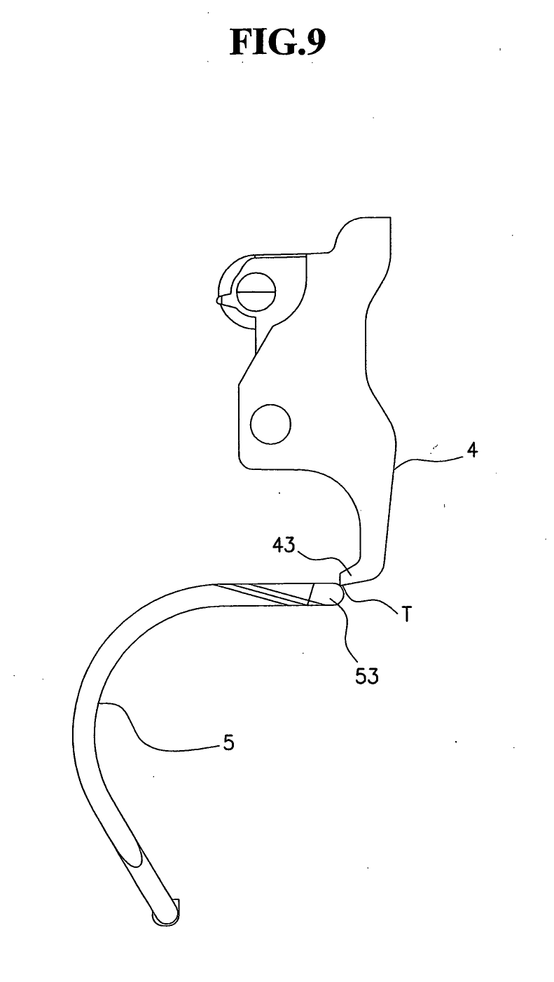

More specifically, as shown in FIG. 9, the ends 43 in the rear of the balance arm part 4 and the distal end part 53 of the spring part 5 are integrally injection-molded via a separable thin part T from one mold, thereby efficiently manufacturing them.

Now, the cam mechanism will be described. The trigger part 6 is pivotally attached to the body part 1 so as to be turnable about a pivotal point P2.

A projecting curved-surface part 6A formed on the trigger part 6 abuts a curved-surface part 4A formed on a front end of the balance arm part 4 (see FIG. 1).

At this point, when the trigger part 6 is pulled inward, the curved-surface part 4A abutting the projecting curved-surface part 6A is pushed up, thereby turning the balance arm part 4.

In this manner, the projecting curved-surface part 6A of the trigger part 6 functions as a cam surface, the curved-surface part 4A of the balance arm part 4 functions as a follower, and the cam mechanism is constituted by both of them.

Incidentally, the present invention employs the principle of transmitting the movement of the trigger part 6 to the balance arm part 4 by using the cam mechanism in this manner; therefore, the trigger part 6 is preferred to be moved uniformly and smoothly as much as possible.

In the trigger-type pump dispenser A of the present invention, the distance L between the contact point Q of the trigger part 6 and the balance arm part 4 (specifically, the contact point of the projecting curved-surface part 6A and the curved-surface part 4A) and the pivotal point P1 of the balance arm part 4 on the body part 1 is designed to be always constant in all the process of the movement of the trigger part 6.

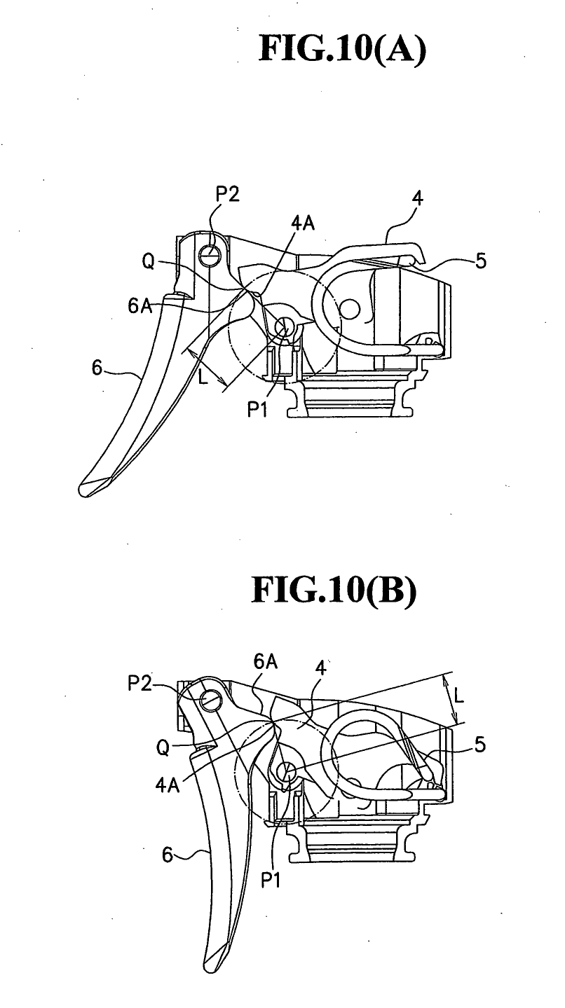

More specifically, as shown in FIG. 10 (A), the distance L between the contact point Q of the trigger part 6 and the balance arm part 4 and the pivotal point P1 of the balance arm part 4 on the body part 1 before the trigger part 6 is pulled is the same even after the trigger part 6 is completely pulled (see FIG. 10 (B)).

The distance L is always constant during turning of the trigger part 6. Therefore, the force to pull the trigger part 6 (pulling force) is also always constant and even.

Unnecessary resistance is not felt by a hand, and fatigue is not caused. This was enabled by the structure which transmits the movement of the trigger part 6 to the balance arm part 4 by the cam mechanism.

The materials of the above described parts are synthetic resins, and the parts are mainly manufactured by injection molding. A polypropylene resin (PP) is suitable for the cylinder part 2, the body part 1, and the cap 11; a polyoxymethylene (polyacetal) resin (POM) is suitable for the trigger part 6; and linear low-density polyethylene resin (LLDPE) is suitable for the piston part 3.

Hereinabove, the present invention has been explained by taking an embodiment thereof as an example; however, the present invention is not limited only to the above described embodiment, and various modifications can be made.

### INDUSTRIAL APPLICABILITY

The trigger-type pump dispenser of the present invention has advantages, for example, that the movement of the swing lever is stabilized and that the biasing means for returning the piston is not affected by the liquid; and the dispenser properly transmits the movement of the trigger part to the balance arm by the cam mechanism.

As long as such characteristics are to be used, the dispenser can be applied to other spray mechanisms other than that of the present invention.

### DESCRIPTION OF REFERENCE NUMERALS

A Pump Dispenser
1 BODY PART
11 CAP
11A CLAW PART
12 ENGAGEMENT HOLE
1A ENGAGEMENT GROOVE
1B BASE-PART PLACEMENT PART
2 CYLINDER PART
2A CYLINDER MAIN BODY PART
2B FIRST DIAMETER-REDUCED PART
2C SECOND DIAMETER-REDUCED PART
3 PISTON PART
31 ROD TUBE PART
32 VALVE SEAT
33 ENGAGEMENT PROJECTION
4 BALANCE ARM PART
41A WALL PART
41B WALL PART
42 ENGAGEMENT PROJECTION
43 REAR END
44 ENGAGEMENT HOLE
4A CURVED-SURFACE PART
5 SPRING PART
51 U-SHAPED BASE PART
52 CURVED SPRING PART
53 DISTAL END PART
6 TRIGGER PART
6A PROJECTING CURVED-SURFACE PART
7 NOZZLE PART
71 NOZZLE OPENING
72 COUPLING PART
8 COVER MEMBER
9 LEAK VALVE
91 BULGED PART
10 TUBE PART
FV FIRST VALVE
FV1 VALVE
FV2 CROSS-SHAPED RIB
SV SECOND VALVE
T THIN PART

1. A trigger-type pump dispenser characterized by comprising: a body part attachable to an opening part of a container main body; a cylinder part integrally provided with the body part; a piston part slidable in the cylinder part; a balance arm part pivotally attached to the body part so as to vertically slide the piston part; a trigger part turning the balance arm part; a spring part for returning the trigger part via the balance arm part; and a cover member attached to the body part; wherein movement of the trigger part is transmitted to the balance arm part by a cam mechanism.

2. The trigger-type pump dispenser according to claim 1, characterized in that the spring part has a U-shaped base part and curved spring parts curved and projected from the U-shaped base part and mutually coupled by a distal end part; and a rear end of the balance arm part is hooked on the distal end part from above in the state in which the balance arm part is partially housed in the curved spring parts.

3. The trigger-type pump dispenser according to claim 1, characterized in that the balance arm part has a pair of wall parts with a distance between the wall parts, and engagement projections respectively formed on both sides of the piston part are inserted in engagement holes respectively formed in the wall parts so as to mutually couple the balance arm part and the piston part.

4. The trigger-type pump dispenser according to claim 1, characterized in that a projecting curved-surface part formed on the trigger part abuts a front end of the balance arm part.

5. The trigger-type pump dispenser according to claim 1, characterized in that the distance between a contact point of the trigger part and the balance arm part and a pivotal point of the balance arm part with respect to a U-shaped base part of the spring part is always constant.

6. The trigger-type pump dispenser according to claim 1, characterized in that the spring part and the balance arm part are integrally formed via a separable thin part.
